(19) United States
(12) Patent Application Publication
(10) Pub. No.: US 2019/0079231 A1
(43) Pub. Date: Mar. 14, 2019

(54) OPTICAL LAMINATE AND IMAGE DISPLAY DEVICE IN WHICH SAID OPTICAL LAMINATE IS USED

(71) Applicants: MITSUBISHI CHEMICAL CORPORATION, Tokyo (JP); NITTO DENKO CORPORATION, Ibaraki-shi, Osaka (JP)

(72) Inventors: Hiroshi Sumimura, Ibaraki-shi (JP); Takashi Shimizu, Ibaraki-shi (JP); Shingo Namiki, Kitakyushu-shi (JP); Yuuichi Hirami, Kitakyushu-shi (JP)

(73) Assignees: MITSUBISHI CHEMICAL CORPORATION, Tokyo (JP); NITTO DENKO CORPORATION, Ibaraki-shi, Osaka (JP)

(21) Appl. No.: 16/072,771

(22) PCT Filed: Jan. 31, 2017
(86) PCT No.: PCT/JP2017/003377

§ 371 Date: Jul. 25, 2018

(30) Foreign Application Priority Data
Feb. 5, 2016 (JP) 2016-021299
Jan. 30, 2017 (JP) 2017-014146

(51) Int. Cl. G02B 5/30; G02F 1/1333; C08G 63/64

(52) U.S. Cl. CPC G02B 5/305; C08G 63/64; G02F 1/13338; G02B 5/3083

(57) ABSTRACT

There is provided an optical laminate that has a conductive layer directly formed on a retardation layer, is extremely thin and has an excellent antireflection function, and further, can realize excellent display characteristics even when it is applied to a bent portion of an image display apparatus. An optical laminate according to an embodiment of the present invention includes: a polarizer; a retardation layer; and a conductive layer, which is directly formed on the retardation layer. The retardation layer has an in-plane retardation Re(550) being from 100 nm to 180 nm and satisfying a relationship of Re(450)<Re(550)<Re(650), and has a glass transition temperature (Tg) of 150° C. or more and an absolute value of a photoelastic coefficient of 20×10⁻¹² (m²/N) or less. An angle formed between a slow axis of the retardation layer and an absorption axis of the polarizer is from 35° to 55°.

### TECHNICAL FIELD

The present invention relates to an optical laminate and an image display apparatus using the optical laminate.

### BACKGROUND ART

The number of opportunities for the use of a display apparatus for, for example, a smart device typified by a smart phone, digital signage, or a window display under strong ambient light has been increasing in recent years. Along with the increase, there has been occurring a problem such as: the reflection of the ambient light by the display apparatus itself or a reflector to be used in the display apparatus, such as a touch panel portion, a glass substrate, or a metal wiring; or the reflection of a background on the display apparatus or the reflector. In particular, an organic electroluminescence (EL) display apparatus that has started to be put into practical use in recent years is liable to cause a problem, such as the reflection of the ambient light or the reflection of the background, because the apparatus has a metal layer having high reflectivity. In view of the foregoing, it has been known that such problem is prevented by arranging, as an antireflection film, a circularly polarizing plate including a retardation film (typically a λ/4 plate) on a viewer side.

Further, in recent years, as typified by smartphones, touch panel-type input display apparatus, which are image display apparatus doubling as touch panel-type input apparatus, have been rapidly increasing in number. In particular, a so-called inner touch panel-type input display apparatus, which includes a built-in touch sensor between a display cell (e.g., a liquid crystal cell or an organic EL cell) and a polarizing plate, has been put into practical use. In such inner touch panel-type input display apparatus, a transparent conductive layer functioning as a touch panel electrode is introduced by being laminated, as a conductive layer with an isotropic substrate, on a retardation film (typically a λ/4 plate). This is because, although it is desired from the viewpoint of thinning of the display apparatus that the transparent conductive layer be directly formed on the retardation film, optical characteristics of the retardation film significantly deviate from desired characteristics owing to a high-temperature environment in sputtering for forming the transparent conductive layer and posttreatment therefor, and hence there is no choice but to use a substrate for sputtering. Thus, a technology capable of directly forming the transparent conductive layer on the retardation film is strongly desired. In addition, in order to adapt to a flexible display, there is a demand for a circularly polarizing plate whose display characteristics are not impaired even when the circularly polarizing plate is applied to a bent portion of the display.

### CITATION LIST

### Patent Literature

[PTL 1] JP 2015-69158 A

### SUMMARY OF INVENTION

### Technical Problem

The present invention has been made in order to solve the above-described problems, and an object of the present invention is to provide an optical laminate that has a conductive layer directly formed on a retardation layer, is extremely thin and has an excellent antireflection function, and further, can realize excellent display characteristics even when it is applied to a bent portion of an image display apparatus.

### Solution to Problem

An optical laminate according to an embodiment of the present invention includes: a polarizer; a retardation layer; and a conductive layer, which is directly formed on the retardation layer. The retardation layer has an in-plane retardation Re(550) being from 100 nm to 180 nm and satisfying a relationship of Re(450)<Re(550)<Re(650), and has a glass transition temperature (Tg) of 150° C. or more and an absolute value of a photoelastic coefficient of 20×10⁻¹² (m²/N) or less. An angle formed between a slow axis of the retardation layer and an absorption axis of the polarizer is from 35° to 55°.

According to another aspect of the present invention, there is provided an image display apparatus. The image display apparatus includes the above-described optical laminate on a viewer side, wherein the polarizer of the optical laminate is arranged on the viewer side.

### Advantageous Effects of Invention

According to the embodiment of the present invention, through the use of a retardation film having a predetermined in-plane retardation, showing reverse wavelength dispersion dependency, and having a predetermined glass transition temperature and photoelastic coefficient as the retardation layer, the conductive layer can be directly formed on the surface of the retardation layer, and besides, desired optical characteristics of the retardation layer can be maintained despite the formation of such conductive layer. As a result, the optical laminate that is extremely thin and has an excellent antireflection function can be realized. Further, such optical laminate can realize excellent display characteristics even when it is applied to a bent portion of an image display apparatus.

### BRIEF DESCRIPTION OF DRAWINGS

FIG. 1 is a schematic sectional view of an optical laminate according to one embodiment of the present invention.

### DESCRIPTION OF EMBODIMENTS

Now, typical embodiments of the present invention are described. However, the present invention is not limited to these embodiments.

### Definitions of Terms and Symbols

The definitions of terms and symbols used herein are as follows.

### (1) Refractive Indices (Nx, Ny, and Nz)

A symbol “nx” represents a refractive index in a direction in which an in-plane refractive index is maximum (that is, slow axis direction), “ny” represents a refractive index in a direction perpendicular to the slow axis in the plane (that is, fast axis direction), and “nz” represents a refractive index in a thickness direction.

### (2) In-Plane Retardation (Re)

The term “Re (λ)” refers to the in-plane retardation of a film measured at 23° C. with light having a wavelength of λ nm. For example, the term “Re(450)” refers to the in-plane retardation of the film measured at 23° C. with light having a wavelength of 450 nm. The Re(λ) is determined from the equation “Re=(nx−ny)×d” when the thickness of the film is represented by d (nm).

### (3) Thickness Direction Retardation (Rth)

The term “Rth(λ)” refers to the thickness direction retardation of the film measured at 23° C. with light having a wavelength of A nm. For example, the term “Rth(450)” refers to the thickness direction retardation of the film measured at 23° C. with light having a wavelength of 450 nm. The Rth(A) is determined from the equation “Rth=(nx−nz)×d” when the thickness of the film is represented by d (nm).

### (4) Nz Coefficient

An Nz coefficient is determined from the equation “Nz=Rth/Re”.

### (5) Angle

When reference is made to an angle in this description, the angle comprehends angles in both a clockwise direction and a counterclockwise direction unless otherwise stated.

A. Overall Configuration of Optical Laminate

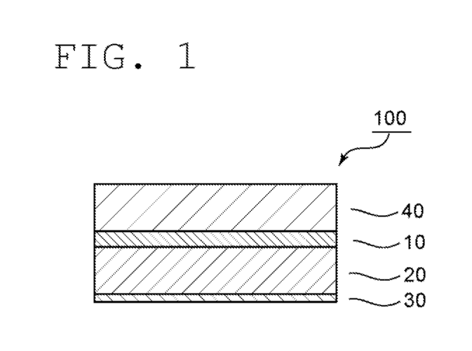

FIG. 1 is a schematic sectional view of an optical laminate according to one embodiment of the present invention. An optical laminate 100 according to this embodiment includes a polarizer 10, a retardation layer 20, and a conductive layer 30 directly formed on the retardation layer 20. In practical use, as in the illustrated example, the optical laminate 100 may further include a protective layer 40, which is bonded to the opposite side of the polarizer 10 to the retardation layer 20. In addition, the optical laminate 100 may further include a protective layer (an inner protective layer: not shown) between the polarizer 10 and the retardation layer 20. According to such configuration, the optical laminate can be applied to a so-called inner touch panel-type input display apparatus, which includes a built-in touch sensor between a display cell (e.g., a liquid crystal cell or an organic EL cell) and a polarizer.

Each layer (each optical film) is bonded through the intermediation of any appropriate adhesion layer (typically an adhesive layer or a pressure-sensitive adhesive layer). Meanwhile, as described above, the conductive layer 30 is directly formed on the retardation layer 20. Herein, the phrase “directly formed” refers to being laminated without the intermediation of an adhesion layer. The conductive layer 30 may be typically formed on the surface of the retardation layer 20 by sputtering. In the illustrated example, the conductive layer 30 is formed on the opposite side of the retardation layer 20 to the polarizer 10 (below the retardation layer), but may be formed between the retardation layer 20 and the polarizer 10 (above the retardation layer). An index-matching (IM) layer and/or a hard coat (HC) layer (none of which is shown) may be formed between the retardation layer and the conductive layer in some cases depending on purposes. In such cases, the conductive layer is directly formed on the IM layer or the HC layer by sputtering. Such mode is also encompassed in the mode of being “directly formed”. The IM layer and the HC layer may each adopt a configuration to be generally used in the art, and hence detailed description thereof is omitted.

In the embodiment of the present invention, the retardation layer 20 typically includes a retardation film. Therefore, the retardation layer may also function as a protective layer (inner protective layer) for the polarizer. As a result, the retardation layer can contribute to the thinning of the optical laminate (consequently of an image display apparatus). As described above, as required, an inner protective layer (inner protective film) may be arranged between the polarizer and the retardation layer. The retardation layer has an in-plane retardation Re(550) being from 100 nm to 180 nm and satisfying a relationship of Re(450)<Re(550)<Re(650). Further, the retardation layer has a glass transition temperature (Tg) of 150° C. or more and an absolute value of a photoelastic coefficient of 20×10⁻¹² (m²/N) or less. With such retardation layer, desired optical characteristics can be maintained even under a high-temperature environment in sputtering and accompanying posttreatment. Therefore, the conductive layer can be directly formed on the surface of the retardation layer by sputtering. As a result, manufacturing efficiency is markedly enhanced, and besides, a substrate for sputtering and a pressure-sensitive adhesive layer for bonding a laminate of the conductive layer and the substrate can be omitted. Accordingly, a contribution can be made to further thinning of the optical laminate (consequently of an image display apparatus). Further, such optical laminate can realize excellent display characteristics even when it is applied to a bent portion of an image display apparatus. More specifically, a change in tinge between the bent portion and a flat portion can be suppressed.

An angle formed between the slow axis of the retardation layer 20 and the absorption axis of the polarizer 10 is typically from 35° to 55°. When the angle falls within such range, an optical laminate having an extremely excellent circular polarization characteristic (consequently an extremely excellent antireflection characteristic) can be obtained by setting the in-plane retardation of the retardation layer to the range as described above.

As required, an antiblocking (AB) layer may be arranged on the opposite side of the conductive layer 30 to the retardation layer 20 (outermost side of the optical laminate). The haze value of the AB layer is preferably from 0.2% to 4%.

The total thickness of the optical laminate (e.g., total thickness of protective layer/adhesion layer/polarizer/adhesion layer/protective layer/adhesion layer/retardation layer/conductive layer) is preferably from 50 μm to 200 μm, more preferably from 80 μm to 170 μm. According to the embodiment of the present invention, the conductive layer can be directly formed on the surface of the retardation layer and a substrate for sputtering can be omitted, and hence remarkable thinning can be realized.

In one embodiment, the optical laminate of the present invention has an elongate shape. The optical laminate having an elongate shape may be, for example, rolled into a roll shape to be stored and/or transported.

The above-mentioned embodiments may be combined as appropriate, modifications obvious in the art may be made to the constituent elements in the embodiments, and the configurations in the embodiments may each be replaced with an optically equivalent configuration.

Now, the constituent elements of the optical laminate are described.

B. Polarizer

Any appropriate polarizer may be adopted as the polarizer 10. For example, a resin film for forming the polarizer may be a single-layer resin film, or may be a laminate of two or more layers.

Specific examples of the polarizer constituted of a single-layer resin film include: a product obtained by subjecting a hydrophilic polymer film such as a polyvinyl alcohol-based film, a partially formalized polyvinyl alcohol-based film, or an ethylene-vinyl acetate copolymer-based partially saponified film to dyeing treatment with a dichromatic substance such as iodine or a dichromatic dye and stretching treatment; and a polyene-based alignment film such as a dehydration-treated product of polyvinyl alcohol or a dehydrochlorination-treated product of polyvinyl chloride. Of those, a polarizer obtained by dyeing a polyvinyl alcohol-based film with iodine and uniaxially stretching the resultant is preferably used because of its excellent optical characteristics.

The dyeing with iodine is performed by, for example, immersing the polyvinyl alcohol-based film in an aqueous solution of iodine. The stretching ratio of the uniaxial stretching is preferably from 3 to 7 times. The stretching may be performed after the dyeing treatment or may be performed simultaneously with the dyeing. In addition, the stretching may be performed before the dyeing. The polyvinyl alcohol-based film is subjected to, for example, swelling treatment, cross-linking treatment, washing treatment, or drying treatment as required. For example, when the polyvinyl alcohol-based film is washed with water by being immersed in water before the dyeing, the soil or antiblocking agent on the surface of the polyvinyl alcohol-based film can be washed off. In addition, the polyvinyl alcohol-based film can be swollen to prevent dyeing unevenness or the like.

The polarizer obtained by using the laminate is, for example, a polarizer obtained by using a laminate of a resin substrate and a PVA-based resin layer (PVA-based resin film) laminated on the resin substrate, or a laminate of a resin substrate and a PVA-based resin layer formed on the resin substrate through application. The polarizer obtained by using the laminate of the resin substrate and the PVA-based resin layer formed on the resin substrate through application may be produced by, for example, a method involving: applying a PVA-based resin solution onto the resin substrate; drying the solution to form the PVA-based resin layer on the resin substrate, thereby providing the laminate of the resin substrate and the PVA-based resin layer; and stretching and dyeing the laminate to turn the PVA-based resin layer into the polarizer. In this embodiment, the stretching typically includes the stretching of the laminate under a state in which the laminate is immersed in an aqueous solution of boric acid. The stretching may further include the in-air stretching of the laminate at high temperature (e.g., 95° C. or more) before the stretching in the aqueous solution of boric acid as required. The resultant laminate of the resin substrate and the polarizer may be used as it is (i.e., the resin substrate may be used as a protective layer for the polarizer). Alternatively, a product obtained as described below may be used: the resin substrate is peeled from the laminate of the resin substrate and the polarizer, and any appropriate protective layer in accordance with purposes is laminated on the peeled surface. Details of such method of producing a polarizer are disclosed in, for example, Japanese Patent Application Laid-open No. 2012-73580. The entire disclosure of the laid-open publication is incorporated herein by reference.

The thickness of the polarizer is preferably 15 μm or less, more preferably from 1 μm to 12 μm, still more preferably from 3 μm to 10 μm, particularly preferably from 3 μm to 8 μm. When the thickness of the polarizer falls within such range, curling at the time of heating can be satisfactorily suppressed, and satisfactory external appearance durability at the time of heating is obtained. In addition, the polarizer having such thickness can contribute to the thinning of the optical laminate (consequently of an organic EL display apparatus).

The polarizer preferably shows absorption dichroism at any wavelength in the wavelength range of from 380 nm to 780 nm. The single layer transmittance of the polarizer is preferably from 43.0% to 46.0%, more preferably from 44.5% to 46.0%. The polarization degree of the polarizer is preferably 97.0% or more, more preferably 99.0% or more, still more preferably 99.9% or more.

C. Retardation Layer

The in-plane retardation Re(550) of the retardation layer 20 is from 100 nm to 180 nm as described above, and is preferably from 120 nm to 160 nm, more preferably from 135 nm to 155 nm. That is, the retardation layer may function as a so-called λ/4 plate.

As described above, the retardation layer satisfies a relationship of Re(450)<Re(550)<Re(650). That is, the retardation layer shows such reverse wavelength dispersion dependency that its retardation value increases with an increase in wavelength of measurement light. A ratio Re (450)/Re (550) of the retardation layer is preferably 0.7 or more and less than 1.0, more preferably 0.8 or more and less than 1.0, still more preferably 0.8 or more and less than 0.95, particularly preferably 0.8 or more and less than 0.9. A ratio Re(550)/Re(650) of the retardation layer is preferably 0.8 or more and less than 1.0, more preferably from 0.8 to 0.97.

The retardation layer typically has: a refractive index characteristic of showing a relationship of nx>ny; and a slow axis. The angle formed between the slow axis of the retardation layer 20 and the absorption axis of the polarizer 10 is from 35° to 55° as described above, and is more preferably from 38° to 52°, still more preferably from 42° to 48°, particularly preferably about 45°. When the angle falls within such range, an optical laminate having an extremely excellent circular polarization characteristic (consequently an extremely excellent antireflection characteristic) can be obtained by using the retardation layer as a λ/4 plate.

The retardation layer shows any appropriate refractive index ellipsoid (refractive index characteristic) as long as the layer has the relationship of nx>ny. The refractive index ellipsoid of the retardation layer preferably shows a relationship of nx>ny nz or nx>nz>ny. Herein, “ny=nz” encompasses not only a case in which ny and nz are exactly equal to each other, but also a case in which ny and nz are substantially equal to each other. Therefore, a relationship of ny<nz may be satisfied without impairing the effect of the present invention. The Nz coefficient of the retardation layer is preferably from 0.2 to 2.0, more preferably from 0.2 to 1.5, still more preferably from 0.2 to 1.0. When such relationship is satisfied, in the case of using the optical laminate for an image display apparatus, an extremely excellent reflection hue can be achieved.

As described above, the glass transition temperature (Tg) of the retardation layer is 150° C. or more. The lower limit of the glass transition temperature is more preferably 155° C. or more, still more preferably 157° C. or more, even still more preferably 160° C. or more, particularly preferably 163° C. or more. Meanwhile, the upper limit of the glass transition temperature is preferably 180° C. or less, more preferably 175° C. or less, particularly preferably 170° C. or less. When the glass transition temperature is excessively low, undesired changes may occur in optical characteristics under a high-temperature environment in sputtering and accompanying posttreatment. When the glass transition temperature is excessively high, forming stability at the time of the formation of the retardation layer may be deteriorated, and besides, the transparency of the retardation layer may be impaired. The glass transition temperature is determined in conformity to JIS K 7121 (1987).

The absolute value of the photoelastic coefficient of the retardation layer is 20×10⁻¹ (m²/N) or less as described above, and is preferably from 1.0×10⁻¹² (m²/N) to 15×10⁻¹² (m²/N), more preferably from 2.0×10⁻¹² (m²/N) to 12×10⁻¹² (m²/N). When the absolute value of the photoelastic coefficient falls within such range, a change between tinges before and after sputtering can be suppressed. Further, when the optical laminate is applied to a bent portion of an image display apparatus, excellent display characteristics can be realized even at the bent portion.

The thickness of the retardation layer may be set so that the retardation layer can most appropriately function as a λ/4 plate. In other words, the thickness may be set so that a desired in-plane retardation can be obtained. Specifically, the thickness is preferably from 10 μm to 80 μm, more preferably from 10 μm to 70 μm, still more preferably from 20 μm to 65 μm, particularly preferably from 20 μm to 60 μm, most preferably from 20 μm to 50 μm.

The retardation layer includes a retardation film containing any appropriate resin that can satisfy the characteristics as described above. Examples of the resin for forming the retardation film include a polycarbonate resin, a polyvinyl acetal resin, a cycloolefin-based resin, an acrylic resin, and a cellulose ester-based resin. Of those, a polycarbonate resin is preferred. The polycarbonate resin allows molecular design for adjusting a balance among various physical properties by virtue of relative ease with which a copolymer is synthesized using a plurality of kinds of monomers. In addition, its heat resistance, stretchability, mechanical properties, and the like are also relatively satisfactory. In the present invention, the polycarbonate resin collectively refers to resins each having a carbonate bond in a structural unit thereof, and encompasses, for example, a polyester carbonate resin. The polyester carbonate resin refers to a resin having a carbonate bond and an ester bond as structural units constituting the resin.

It is preferred that the polycarbonate resin to be used in the present invention contain at least a structural unit represented by the below-indicated formula (1) or (2):

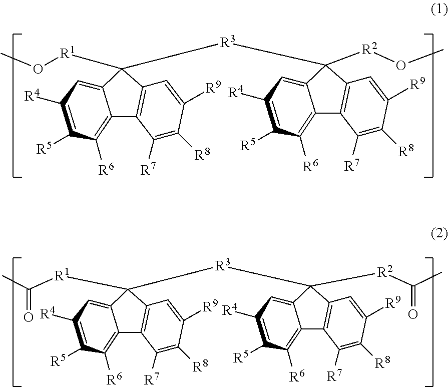

in the formulae (1) and (2), R¹ to R³ each independently represent a direct bond, or an alkylene group having 1 to 4 carbon atoms that may have a substituent, and R⁴ to R⁹ each independently represent a hydrogen atom, an alkyl group having 1 to 10 carbon atoms that may have a substituent, an aryl group having 4 to 10 carbon atoms that may have a substituent, an acyl group having 1 to 10 carbon atoms that may have a substituent, an alkoxy group having 1 to 10 carbon atoms that may have a substituent, an aryloxy group having 1 to 10 carbon atoms that may have a substituent, an amino group that may have a substituent, a vinyl group having 1 to 10 carbon atoms that may have a substituent, an ethynyl group having 1 to 10 carbon atoms that may have a substituent, a sulfur atom having a substituent, a silicon atom having a substituent, a halogen atom, a nitro group, or a cyano group, provided that R⁴ to R⁹ may be identical to or different from each other, and at least two adjacent groups of R⁴ to R⁹ may be bonded to each other to form a ring.

The above-described structural unit can allow a reverse wavelength dispersion property to be efficiently expressed even when its content in the resin is small. In addition, a resin containing the above-described structural unit also has satisfactory heat resistance and provides high birefringence when stretched, and hence has characteristics suited for the retardation layer to be used in the present invention.

In order to achieve the optimal wavelength dispersion characteristic in the retardation film, the content of the structural unit represented by the formula (1) or (2) in the resin is preferably 1 wt % or more and 50 wt % or less, more preferably 3 wt % or more and 40 wt % or less, particularly preferably 5 wt % or more and 30 wt % or less with respect to 100 wt % of the total weight of all structural units and linking groups constituting the polycarbonate resin.

Of the structural units represented by the formulae (1) and (2), structures having skeletons exemplified by the below-indicated group [A] are specifically given as preferred structures.

### [A]

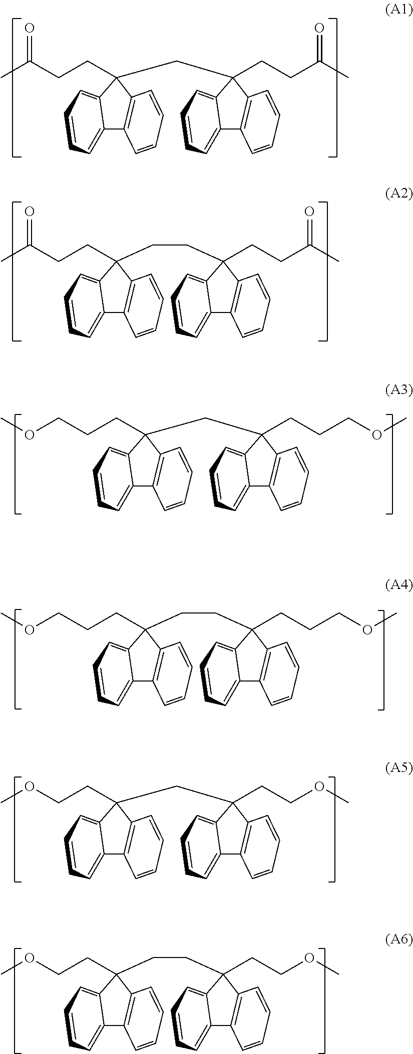

Of the group [A], the diester structural units (A1) and (A2) each have high performance, and (A1) is particularly preferred. The specific diester structural units each have more satisfactory thermal stability than the dihydroxy compound-derived structural unit represented by the formula (1), and tend to show satisfactory characteristics in terms of optical characteristics, such as the property of expressing reverse wavelength dispersion and the photoelastic coefficient, as well. When the polycarbonate resin according to the present invention contains a diester structural unit, such resin is referred to as polyester carbonate resin.

The polycarbonate resin to be used in the present invention allows the design of a resin satisfying various physical properties required for the retardation layer to be used in the present invention by containing other structural units together with the structural unit represented by the formula (1) or (2). In order to impart high heat resistance, which is a particularly important physical property, the polycarbonate resin preferably contains a structural unit represented by the below-indicated formula (3):

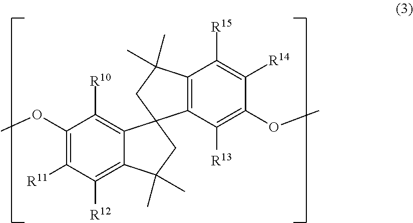

in the formula (3), R¹⁰ to R¹⁵ each independently represent a hydrogen atom, an alkyl group having 1 to 12 carbon atoms, an aryl group, an alkoxy group having 1 to 12 carbon atoms, or a halogen atom.

The structural unit represented by the formula (3) is a component having a high glass transition temperature and has a relatively low photoelastic coefficient despite being an aromatic structure, and hence satisfies the characteristics required for the retardation layer to be used in the present invention.

The content of the structural unit represented by the formula (3) in the resin is preferably 1 wt % or more and 30 wt % or less, more preferably 2 wt % or more and 20 wt % or less, particularly preferably 3 wt % or more and 15 wt % or less with respect to 100 wt % of the total weight of all structural units and linking groups constituting the polycarbonate resin. When the content falls within this range, while sufficient heat resistance is imparted, the resin does not become excessively brittle, and hence a resin excellent in processability can be obtained.

The structural unit represented by the formula (3) may be introduced into the resin by polymerizing a dihydroxy compound containing the structural unit. 6,6′-Dihydroxy-3,3,3′,3′-tetramethyl-1,1′-spirobiindane is particularly preferably used as the dihydroxy compound from the viewpoints of having satisfactory physical properties and being easily available.

The polycarbonate resin to be used in the present invention preferably further contains a structural unit represented by the below-indicated formula (4).

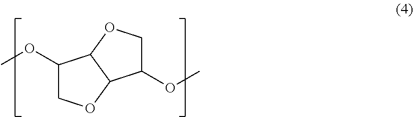

The structural unit represented by the formula (4) has the characteristics as follows: the property of expressing birefringence when the resin is stretched is high, and besides, the photoelastic coefficient is low. As a dihydroxy compound capable of introducing the structural unit represented by the formula (4), there are given isosorbide (ISB), isomannide, and isoidide, which are in a stereoisomeric relationship. Of those, ISB is most preferably used from the viewpoints of availability and polymerization reactivity.

The polycarbonate resin to be used in the present invention may contain any other structural unit besides the above-mentioned structural units depending on required physical properties. Examples of the monomer containing the other structural unit include an aliphatic dihydroxy compound, an alicyclic dihydroxy compound, a dihydroxy compound having an acetal ring, oxyalkylene glycols, a dihydroxy compound containing an aromatic component, and a diester compound. Of those, a dihydroxy compound, such as 1,4-cyclohexanedimethanol (hereinafter sometimes abbreviated as CHDM), tricyclodecanedimethanol (hereinafter sometimes abbreviated as TCDDM), or spiroglycol (hereinafter sometimes abbreviated as SPG), is preferably used from the viewpoints of satisfactory balance among various physical properties and availability.

The polycarbonate resin to be used in the present invention may contain, for example, a heat stabilizer, an antioxidant, a catalyst deactivator, a UV absorber, a light stabilizer, a release agent, a dye and a pigment, an impact improver, an antistatic agent, a lubricant, a lubricity agent, a plasticizer, a compatibilizer, a nucleating agent, a flame retardant, an inorganic filler, and a foaming agent, which are commonly used, to the extent that the object of the present invention is not impaired.

The polycarbonate resin to be used in the present invention may be a polymer alloy formed by mixing and kneading with one kind or two or more kinds selected from, for example, synthetic resins or rubbers, such as an aromatic polycarbonate, an aliphatic polycarbonate, an aromatic polyester, an aliphatic polyester, polyamide, polystyrene, polyolefin, acryl, amorphous polyolefin, ABS, AS, polylactic acid, and polybutylene succinate, for modification of characteristics, such as a mechanical characteristic and solvent resistance.

The above-mentioned additives and modifiers may be used in the production of the retardation film by mixing the above-mentioned components, simultaneously or in any appropriate order, into the resin to be used in the present invention with a mixer, such as a tumbler, a V-type blender, a Nauta mixer, a Banbury mixer, a kneading roll, or an extruder. Of those, an extruder, in particular, a twin-screw extruder is preferably used to perform kneading from the viewpoint of enhancing dispersibility.

The molecular weight of the polycarbonate resin to be used in the present invention may be expressed as a reduced viscosity. The reduced viscosity is measured with an Ubbelohde viscometer at a temperature of 20.0° C.±0.1° C. after precise adjustment of a polycarbonate resin concentration to 0.6 g/dL through the use of methylene chloride as a solvent. The lower limit of the reduced viscosity is generally preferably 0.25 dL/g or more, more preferably 0.30 dL/g or more, particularly preferably 0.32 dL/g or more. The upper limit of the reduced viscosity is generally preferably 0.50 dL/g or less, more preferably 0.45 dL/g or less, particularly preferably 0.40 dL/g or less. When the reduced viscosity is lower than the lower limit value, there may arise a problem of a reduction in mechanical strength of a formed product. Meanwhile, when the reduced viscosity is higher than the upper limit value, there may arise a problem in that fluidity during forming is decreased to decrease productivity and formability.

The polycarbonate resin to be used in the present invention preferably has a melt viscosity of 1,000 Pa·s or more and 9,000 Pa·s or less at a measurement temperature of 240° C. and a shear rate of 91.2 sec⁻¹. The lower limit of the melt viscosity is more preferably 2,000 Pa·s or more, still more preferably 2,500 Pa s or more, particularly preferably 3,000 Pa s or more. The upper limit of the melt viscosity is more preferably 8,000 Pa·s or less, still more preferably 7,000 Pas or less, even still more preferably 6,500 Pa·s or less, particularly preferably 6,000 Pa·s or less.

The retardation layer to be used in the present invention is required to have high heat resistance. In general, as the heat resistance (glass transition temperature) is increased, the resin tends to become more brittle. However, when the melt viscosity is set to the range as described above, it is also possible to melt-process the resin while keeping mechanical properties that are minimum requirements at the time of the processing of the resin.

The polycarbonate resin to be used in the present invention preferably has a refractive index of 1.49 or more and 1.56 or less at a sodium d-line (589 nm). The refractive index is more preferably 1.50 or more and 1.55 or less.

In order to impart required optical characteristics to the retardation layer to be used in the present invention, an aromatic structure needs to be introduced into the resin. However, the aromatic structure causes a decrease in transmittance of the retardation layer by increasing its refractive index. In addition, the aromatic structure generally has a high photoelastic coefficient, and decreases optical characteristics in general. For the polycarbonate resin to be used in the present invention, it is preferred that a structural unit efficiently expressing required characteristics be selected to minimize the content of the aromatic structure in the resin.

The retardation layer to be used in the present invention is obtained by forming a film from the polycarbonate resin and stretching the film. Any appropriate forming method may be adopted as a method of forming a film from the polycarbonate resin. Specific examples thereof include a compression molding method, a transfer molding method, an injection molding method, an extrusion method, a blow molding method, a powder forming method, a FRP molding method, a cast coating method (e.g., a casting method), a calender method, and a hot-press method. Of those, an extrusion method or a cast coating method, which can increase the smoothness of the film to be obtained and provide satisfactory optical uniformity, is preferred. The cast coating method may cause a problem due to a residual solvent, and hence the extrusion method is particularly preferred, and in particular, a melt-extrusion method using a T-die is preferred from the viewpoints of the productivity of the film and the ease of subsequent stretching treatment. Forming conditions may be appropriately set depending on, for example, the composition and kind of the resin to be used, and the desired characteristics of the retardation layer.

The thickness of the resin film (unstretched film) may be set to any appropriate value depending on, for example, the desired thickness and desired optical characteristics of the retardation film to be obtained, and stretching conditions to be described later. The thickness is preferably from 50 μm to 300 μm.

Any appropriate stretching method and stretching conditions (such as a stretching temperature, a stretching ratio, and a stretching direction) may be adopted for the stretching. Specifically, one kind of various stretching methods, such as free-end stretching, fixed-end stretching, free-end shrinkage, and fixed-end shrinkage, may be employed alone, or two or more kinds thereof may be employed simultaneously or sequentially. With regard to the stretching direction, the stretching may be performed in various directions or dimensions, such as a lengthwise direction, a widthwise direction, a thickness direction, and an oblique direction.

A retardation film having the desired optical characteristics (such as a refractive index characteristic, an in-plane retardation, and an Nz coefficient) can be obtained by appropriately selecting the stretching method and stretching conditions.

In one embodiment, the retardation film is produced by subjecting a resin film to uniaxial stretching or fixed-end uniaxial stretching. The fixed-end uniaxial stretching is specifically, for example, a method involving stretching the resin film in its widthwise direction (lateral direction) while running the film in its lengthwise direction. The stretching ratio is preferably from 1.1 times to 3.5 times.

In another embodiment, the retardation film may be produced by continuously subjecting a resin film having an elongate shape to oblique stretching in the direction of a predetermined angle with respect to its lengthwise direction. When the oblique stretching is adopted, a stretched film having an elongate shape and having an alignment angle that is the predetermined angle with respect to the lengthwise direction of the film (having a slow axis in the direction of the predetermined angle) is obtained, and for example, roll-to-roll manufacture can be performed in its lamination with the polarizer, with the result that the manufacturing process can be simplified. Further, by virtue of a synergistic effect with the fact that the conductive layer can be directly formed on the retardation layer (retardation film), manufacturing efficiency can be markedly enhanced. The predetermined angle may be the angle formed between the absorption axis of the polarizer and the slow axis of the retardation layer in the optical laminate. As described above, the angle is preferably from 35° to 55°, more preferably from 38° to 52°, still more preferably from 42° to 48°, particularly preferably about 45°.

As a stretching machine to be used for the oblique stretching, for example, there is given a tenter stretching machine capable of applying feeding forces, or tensile forces or take-up forces, having different speeds on left and right sides in a lateral direction and/or a longitudinal direction. Examples of the tenter stretching machine include a lateral uniaxial stretching machine and a simultaneous biaxial stretching machine, and any appropriate stretching machine may be used as long as the resin film having an elongate shape can be continuously subjected to the oblique stretching.

Through appropriate control of each of the speeds on the left and right sides in the stretching machine, a retardation film (substantially a retardation film having an elongate shape) having the desired in-plane retardation and having a slow axis in the desired direction can be obtained.

As a method for the oblique stretching, there are given, for example, methods described in JP 50-83482 A, JP 02-113920 A, JP 03-182701 A, JP 2000-9912 A, JP 2002-86554 A, and JP 2002-22944 A.

The stretching temperature of the film may be changed depending on, for example, the desired in-plane retardation value and thickness of the retardation film, the kind of the resin to be used, the thickness of the film to be used, and a stretching ratio. Specifically, the stretching temperature is preferably from Tg-30° C. to Tg+30° C., more preferably from Tg−15° C. to Tg+15° C., most preferably from Tg-10° C. to Tg+10° C. When the stretching is performed at such temperature, a retardation film having characteristics that are appropriate in the present invention can be obtained. Tg refers to the glass transition temperature of the constituent material for the film.

D. Conductive Layer

The conductive layer 30 is typically transparent (that is, the conductive layer is a transparent conductive layer). When the conductive layer is formed on the opposite side of the retardation layer to the polarizer, the optical laminate can be applied to a so-called inner touch panel-type input display apparatus, which includes a built-in touch sensor between a display cell (for example, liquid crystal cell, organic EL cell) and a polarizer.

The conductive layer may be patterned as required. Through the patterning, a conductive part and an insulating part may be formed. As a result, an electrode may be formed. The electrode may function as a touch sensor electrode for detecting contact on a touch panel. The shape of the pattern is preferably a pattern that satisfactorily operates as a touch panel (e.g., a capacitance-type touch panel). Specific examples thereof include patterns described in, for example, JP2011-511357 A, JP2010-164938 A, JP 2008-310550 A, JP 2003-511799 A, and JP 2010-541109 A.

The total light transmittance of the conductive layer is preferably 80% or more, more preferably 85% or more, still more preferably 90% or more. For example, when a conductive nanowire to be described later is used, a transparent conductive layer having formed therein an opening can be formed, and hence a transparent conductive layer having a high light transmittance can be obtained.

The density of the conductive layer is preferably from 1.0 g/cm³ to 10.5 g/cm³, more preferably from 1.3 g/cm³ to 3.0 g/cm³.

The surface resistance value of the conductive layer is preferably from 0.1Ω/□ to 1,000Ω/□, more preferably from 0.5 Ω/□ to 500Ω/□, still more preferably from 1Ω/□ to 250 Ω/□.

Typical examples of the conductive layer include a conductive layer including a metal oxide. Examples of the metal oxide include indium oxide, tin oxide, zinc oxide, indium-tin composite oxide, tin-antimony composite oxide, zinc-aluminum composite oxide, and indium-zinc composite oxide. Of those, indium-tin composite oxide (ITO) is preferred.

The thickness of the conductive layer is preferably from 0.01 μm to 0.05 μm (10 nm to 50 nm), more preferably from 0.01 μm to 0.03 μm (10 nm to 30 nm). When the thickness falls within such range, a conductive layer excellent in conductivity and light transmittance can be obtained.

E. Protective Layer

The protective layer 40 is formed of any appropriate film that may be used as a protective layer for a polarizer. As a material serving as a main component of the film, there are specifically given, for example, cellulose-based resins, such as triacetylcellulose (TAC), and transparent resins, such as polyester-based, polyvinyl alcohol-based, polycarbonate-based, polyamide-based, polyimide-based, polyether sulfone-based, polysulfone-based, polystyrene-based, polynorbornene-based, polyolefin-based, (meth)acrylic, and acetate-based resins. There are also given, for example, thermosetting resins or UV-curable resins, such as (meth)acrylic, urethane-based, (meth)acrylic urethane-based, epoxy-based, and silicone-based resins. There are also given, for example, glassy polymers, such as a siloxane-based polymer. In addition, a polymer film described in JP 2001-343529 A (WO 01/37007 A1) may be used. For example, a resin composition containing a thermoplastic resin having a substituted or unsubstituted imide group on a side chain thereof, and a thermoplastic resin having a substituted or unsubstituted phenyl group and a nitrile group on side chains thereof may be used as a material for the film, and the composition is, for example, a resin composition containing an alternating copolymer formed of isobutene and N-methylmaleimide, and an acrylonitrile-styrene copolymer. The polymer film may be, for example, an extrudate of the resin composition.

As described later, the optical laminate of the present invention is typically arranged on the viewer side of an image display apparatus, and the protective layer 40 is typically arranged on its viewer side. Therefore, the protective layer 40 may be subjected to surface treatment, such as hard coat treatment, antireflection treatment, anti-sticking treatment, or antiglare treatment, as required. Further/alternatively, the protective layer 40 may be subjected to treatment for improving viewability in the case of viewing through polarized sunglasses (typically imparting a circular (elliptical) polarization function or imparting an ultra-high retardation) as required. When such treatment is performed, even in the case of viewing a display screen through a polarizing lens, such as polarized sunglasses, excellent viewability can be realized. Therefore, the optical laminate can be suitably applied even to an image display apparatus that may be used outdoors.

The thickness of the protective layer is preferably from 20 μm to 200 μm, more preferably from 30 μm to 100 μm, still more preferably from 35 μm to 95 μm.

When the inner protective layer is arranged, it is preferred that the inner protective film be optically isotropic. The phrase “be optically isotropic” as used herein refers to having an in-plane retardation Re (550) of from 0 nm to 10 nm and a thickness direction retardation Rth(550) of from −10 nm to +10 nm.

The material, thickness, and the like of the inner protective layer are as described above for the protective layer 40.

F. Antiblocking Layer

The antiblocking layer typically has an uneven surface. The uneven surface may be a fine uneven surface, or may be a surface having a flat portion and a protruding portion. In one embodiment, the surface of the antiblocking layer preferably has an arithmetic average roughness Ra of 50 nm or more. The uneven surface may be formed by, for example, incorporating fine particles into a resin composition for forming the antiblocking layer, and/or causing the resin composition for forming the antiblocking layer to undergo phase separation.

As a resin to be used for the resin composition, there are given, for example, a thermosetting resin, a thermoplastic resin, a UV-curable resin, an electron beam-curable resin, and a two-component resin. Of those, a UV-curable resin is preferred. This is because the antiblocking layer can be efficiently formed by an easy processing operation.

Any appropriate resin may be used as the UV-curable resin. Specific examples thereof include a polyester-based resin, an acrylic resin, a urethane-based resin, an amide-based resin, a silicone-based resin, and an epoxy-based resin. The UV-curable resin encompasses a UV-curable monomer, oligomer, or polymer. In one embodiment of the present invention, urethane (meth)acrylate may be suitably used as the UV-curable resin.

A urethane (meth)acrylate containing, as constituents, (meth)acrylic acid, a (meth)acrylate, a polyol, and a diisocyanate may be used as the urethane (meth)acrylate. The urethane (meth)acrylate can be produced by, for example, producing a hydroxy (meth)acrylate containing one or more hydroxy groups by using at least one monomer selected from (meth)acrylic acid and the (meth)acrylate, and the polyol, and subjecting the hydroxy (meth)acrylate to a reaction with the diisocyanate. The urethane (meth)acrylates may be used alone or in combination thereof.

Any appropriate fine particles may be used as the fine particles. The fine particles preferably each have transparency. As a material for forming such fine particles, there are given a metal oxide, glass, and a resin. Specific examples thereof include: inorganic fine particles of silica, alumina, titania, zirconia, calcium oxide, and the like; organic fine particles of polymethyl methacrylate, polystyrene, polyurethane, an acrylic resin, an acrylic-styrene copolymer, benzoguanamine, melamine, polycarbonate, and the like; and silicone-based particles. The fine particles may be used alone or in combination thereof. Of those, organic fine particles are preferred, and fine particles of an acrylic resin are more preferred. This is because their refractive indices are appropriate.

The mode particle diameter of the fine particles may be appropriately set depending on the antiblocking property, haze, and the like of the antiblocking layer. The mode particle diameter of the fine particles falls within the range of from, for example, 50% of the thickness of the antiblocking layer to 150% thereof. Herein, the “mode particle diameter” refers to a particle diameter indicating a maximum value of a particle distribution, and is determined by measurement with a flow particle image analyzer (manufactured by Sysmex Corporation, product name: “FPTA-3000S”) under predetermined conditions (Sheath liquid: ethyl acetate, measurement mode: HPF measurement, measuring method: total count). As a measurement sample, there may be used a dispersion obtained by diluting the particles with ethyl acetate to 1.0 wt % and uniformly dispersing the particles with an ultrasonic cleaning machine.

The content of the fine particles is preferably from 0.05 part by weight to 1.0 part by weight, more preferably from 0.1 part by weight to 0.5 part by weight, still more preferably from 0.1 part by weight to 0.2 part by weight with respect to 100 parts by weight of the solid content of the resin composition. When the content of the fine particles is excessively small, the antiblocking property may become insufficient. When the content of the fine particles is excessively large, the haze of the antiblocking layer may be increased to make the viewability of the optical laminate (finally of an image display apparatus) insufficient in some cases.

The resin composition may further contain any appropriate additive depending on purposes. Specific examples of the additive include a reactive diluent, a plasticizer, a surfactant, an antioxidant, a UV absorber, a leveling agent, a thixotropic agent, and an antistatic agent. The number, kinds, combination, addition amounts, and the like of the additives may be appropriately set depending on purposes.

The antiblocking layer may be typically formed by applying a resin composition onto the surface of any appropriate substrate and curing the applied resin composition. Any appropriate method may be adopted as an application method. Specific examples of the application method include a dip coating method, an air knife coating method, a curtain coating method, a roller coating method, a wire bar coating method, a gravure coating method, a die coating method, and an extrusion coating method.

A curing method may be appropriately selected depending on the kind of the resin contained in the resin composition. For example, when a UV-curable resin is used, the antiblocking layer may be formed by appropriately curing the resin composition through irradiation with UV light at an exposure dose of, for example, 150 mJ/cm² or more, preferably from 200 mJ/cm² to 1,000 mJ/cm².

The thickness of the antiblocking layer is preferably from 0.5 μm to 2.0 μm, more preferably from 0.8 μm to 1.5 μm. With such thickness, a satisfactory antiblocking property can be secured without adversely affecting optical characteristics desired for the optical laminate.

The haze value of the antiblocking layer is preferably from 0.2% to 4% as described above, and is more preferably from 0.5% to 3%. When the haze value falls within such range, there is an advantage in that blocking between films can be prevented without a loss of viewability.

The details of the configuration, material, forming method, and the like of the antiblocking layer are described in, for example, JP 2015-115171 A, JP 2015-141674 A, JP 2015-120870 A, and JP 2015-005272 A. The descriptions thereof are incorporated herein by reference.

G. Image Display Apparatus

The optical laminate described in the section A to the section F may be applied to an image display apparatus. Therefore, the present invention encompasses an image display apparatus using such optical laminate. Typical examples of the image display apparatus include a liquid crystal display apparatus and an organic EL display apparatus. An image display apparatus according to an embodiment of the present invention includes, on its viewer side, the optical laminate described in the section A to the section F. The optical laminate is arranged so that the conductive layer may be arranged on a display cell (e.g., liquid crystal cell or organic EL cell) side (so that the polarizer may be arranged on the viewer side). The image display apparatus is bendable in one embodiment, and is foldable in another embodiment.

### EXAMPLES

Now, the present invention is specifically described by way of Examples. However, the present invention is not limited by these Examples. Measurement methods for characteristics are as described below.

(1) Thickness

The thickness of a conductive layer was measured by an interference thickness measurement method with MCPD2000 manufactured by Otsuka Electronics Co., Ltd. The thickness of any other film was measured with a digital micrometer (KC-351C manufactured by Anritsu Corporation).

(2) Retardation Value of Retardation Layer

The refractive indices nx, ny, and nz of a retardation layer (retardation film) used in each of Examples and Comparative Examples were measured with an automatic birefringence measuring apparatus (manufactured by Oji Scientific Instruments Co., Ltd., Automatic Birefringence Analyzer KOBRA-WPR). The measurement wavelengths for an in-plane retardation Re were 450 nm and 550 nm, the measurement wavelength for a thickness direction retardation Rth was 550 nm, and the measurement temperature was 23° C.

(3-1) Reflection Hue

An optical laminate was mounted to an obtained organic EL display apparatus substitute, and measured for its reflection hue with a spectrophotometer CM-2600d manufactured by Konica Minolta, Inc. A case in which the absolute values of both a* and b* were 10 or less, and a reflectance Y was 30% or less was marked with Symbol “o”, and a case in which at least one of a*, b*, and the reflectance exceeded the above-mentioned range was marked with Symbol “x”.

(3-2) Evaluation of Color Unevenness at Bent Portion

An optical laminate mounted to an obtained curved display apparatus substitute was visually observed for its tinge, and was marked with Symbol “o” when a color change between a bent portion and a flat portion was small, or marked with Symbol “x” when the color change was large.

(4) Photoelastic Coefficient

A retardation film used in each of Examples and Comparative Examples was cut into a size of 20 mm×100 mm to produce a sample. The sample was subjected to measurement with light having a wavelength of 550 nm through the use of an ellipsometer (manufactured by JASCO Corporation, M-150), and thus a photoelastic coefficient was obtained.

(5) Reduced Viscosity

A resin sample was dissolved in methylene chloride to precisely prepare a resin solution having a concentration of 0.6 g/dL. Measurement was performed at a temperature of 20.0° C.±0.1° C. with an Ubbelohde-type viscometer manufactured by Moritomo Rika Kogyo, and the flow-through time t₀ of the solvent and the flow-through time t of the solution were measured. A relative viscosity ηᵣₑₗ was determined by the below-indicated equation (i) using the resultant values for t₀ and t, and a specific viscosity ηₛₚ was determined by the below-indicated equation (ii) using the resultant relative viscosity ηᵣₑₗ.

ηᵣₑₗ=t/t₀ (i)

ηₛₚ=(η−η₀)/η₀=ηᵣₑₗ−1 (ii)

Then, a reduced viscosity ηₛₚ/c was determined by dividing the resultant specific viscosity ηₛₚ by the concentration c [g/dL].

(6) Glass Transition Temperature

Measurement was performed with a differential scanning calorimeter DSC6220 manufactured by SII NanoTechnology Inc. About 10 mg of a resin sample was placed in an aluminum pan manufactured by SII NanoTechnology Inc., and the aluminum pan was sealed. Under a nitrogen stream at 50 mL/min, the temperature was increased from 30° C. to 220° C. at a temperature increase rate of 20° C./min. The temperature was kept at 220° C. for 3 minutes, and then lowered to 30° C. at a rate of 20° C./min. The temperature was kept at 30° C. for 3 minutes, and increased again to 220° C. at a rate of 20° C./min. On the basis of DSC data obtained in the second temperature increase, an extrapolated glass transition starting temperature, which was a temperature at a point of intersection of a straight line created by extending the baseline at lower temperatures to higher temperatures and a tangent drawn at a point at which a curve gradient in a portion showing a stepwise change of glass transition became maximum, was determined, and adopted as a glass transition temperature.

(7) Melt Viscosity

A pelletized resin sample was vacuum-dried at 90° C. for 5 hours or more. Measurement was performed with a capillary rheometer manufactured by Toyo Seiki Seisaku-sho, Ltd. using the dried pellet. A melt viscosity was measured at a measurement temperature of 240° C. and shear rates between 9.12 sec⁻¹ and 1,824 sec⁻¹, and the value of the melt viscosity at 91.2 sec⁻¹ was used. An orifice used was one measuring φ1 mm in die diameter by 10 mmL.

(8) Refractive Index

A rectangular test piece having a length of 40 mm and a width of 8 mm was cut out of an unstretched film produced in each of Examples and Comparative Examples to be described later, and was used as a measurement sample. A refractive index n_{D} was measured with a multi-wavelength Abbe refractometer DR-M4/1550 manufactured by Atago Co., Ltd. through the use of a 589 nm (D-line) interference filter. The measurement was performed at 20° C. using monobromonaphthalene as an interfacial liquid.

(9) Total Light Transmittance

The unstretched film was used as a measurement sample, and measured for its total light transmittance with a turbidity meter COH 400 manufactured by Nippon Denshoku Industries Co., Ltd.

(Synthesis Examples of Monomers)

### [Synthesis Example 1] Synthesis of Bis[9-(2-phenoxycarbonylethyl)fluoren-9-yl]methane (BPFM)

Synthesis was performed by a method described in JP 2015-25111 A.

### [Synthesis Example 2] Synthesis of 6,6′-Dihydroxy-3,3,3′,3′-tetramethyl-1,1′-spirobiindane (SBI)

Synthesis was performed by a method described in JP 2014-114281 A.

### Synthesis Examples of Polycarbonate Resins, and Characteristic Evaluations

Abbreviations and the like of compounds used in the below-indicated Examples and Comparative Examples are as follows.
BPFM: bis[9-(2-phenoxycarbonylethyl)fluoren-9-yl]methane
BCF: 9,9-bis(4-hydroxy-3-methylphenyl)fluorene (manufactured by Osaka Gas Chemicals Co., Ltd.)
BHEPF: 9,9-bis[4-(2-hydroxyethoxy)phenyl fluorene (manufactured by Osaka Gas Chemicals Co., Ltd.)
ISB: isosorbide (manufactured by Roquette Frères SA, product name: POLYSORB)
SBI: 6,6′-dihydroxy-3,3,3′,3′-tetramethyl-1,1′-spirobiindane
SPG: spiroglycol (manufactured by Mitsubishi Gas Chemical Company, Inc.)
PEG: polyethylene glycol, number-average molecular weight: 1,000 (manufactured by Sanyo Chemical Industries, Ltd.)
DPC: diphenyl carbonate (manufactured by Mitsubishi Chemical Corporation)

### Example 1

### (Production of Retardation Layer)

6.04 Parts by weight (0.020 mol) of SBI, 59.58 parts by weight (0.408 mol) of ISB, 34.96 parts by weight (0.055 mol) of BPFM, 79.39 parts by weight (0.371 mol) of DPC, and 7.53×10⁻⁴ part by weight (4.27×10⁻⁶ mol) of calcium acetate monohydrate serving as a catalyst were loaded into a reaction vessel, and the reaction apparatus was purged with nitrogen while the pressure therein was reduced. Under a nitrogen atmosphere, the raw materials were dissolved while being stirred at 150° C. for about 10 minutes. As a first step of a reaction, the temperature was increased to 220° C. over 30 minutes, and the solution was subjected to a reaction for 60 minutes at normal pressure. Then, the pressure was reduced from normal pressure to 13.3 kPa over 90 minutes, and kept at 13.3 kPa for 30 minutes to remove generated phenol from the reaction system. Then, as a second step of the reaction, while the heating medium temperature was increased to 245° C. over 15 minutes, the pressure was reduced to 0.10 kPa or less over 15 minutes to remove generated phenol from the reaction system. After predetermined stirring torque had been reached, the reaction was stopped by returning the pressure to normal pressure with nitrogen. A produced polyester carbonate resin was extruded into water and the strand was cut to provide pellets. The resultant resin had a reduced viscosity of 0.375 dL/g, a glass transition temperature of 165° C., a melt viscosity of 5,070 Pa·s, a refractive index of 1.5454, and a photoelastic coefficient of 15×10⁻¹² m²/N.

The resin pellets, which had been vacuum-dried at 100° C. for 5 hours or more, were extruded from a T-die (width: 200 mm, preset temperature: 250° C.) through the use of a single-screw extruder manufactured by Isuzu Kakoki (screw diameter: 25 mm, cylinder preset temperature: 255° C.). The extruded film was taken up into a roll shape with a take-up unit while being cooled with a chill roll (preset temperature: 155° C.) to produce a film having a thickness of 100 μm as an unstretched film. A rectangular test piece measuring 120 mm×150 mm was cut out of the thus obtained polycarbonate resin film with a safety razor, and uniaxially stretched in its lengthwise direction at a ratio of 1×2.4 times with a batch-type biaxial stretching apparatus (manufactured by Bruckner) at a stretching temperature of 171° C. and a stretching speed of 5 mm/sec.

Thus, a retardation film (thickness: 64 μm) was obtained. The resultant retardation film had an Re(550) of 147 nm and an Rth(550) of 147 nm, and showed a refractive index characteristic of nx>ny=nz. In addition, the resultant retardation film had a ratio Re(450)/Re(550) of 0.81. The slow axis direction of the retardation film was 0° with respect to its lengthwise direction.

(Production of Laminate of Retardation Layer and Conductive Layer)

A transparent conductive layer (thickness: 20 nm) formed of an indium-tin composite oxide was formed on the surface of the retardation film (retardation layer) by sputtering to produce a laminate of the retardation layer and the conductive layer. A specific procedure is as follows: under a vacuum atmosphere (0.40 Pa) into which Ar and O₂ (at a flow rate ratio of Ar:O₂=99.9:0.1) were introduced, a sintered body of 10 wt % of tin oxide and 90 wt % of indium oxide was used as a target, and an RF-superimposed DC-magnetron sputtering method at a film temperature of 130° C. and a horizontal magnetic field of 100 mT (discharge voltage: 150 V, RF frequency: 13.56 MHz, ratio of RF power to DC power (RF power/DC power): 0.8) was used. The resultant transparent conductive layer was subjected to crystallizing treatment by being heated in a hot-air oven at 150° C.

(Production of Polarizer)

An elongate roll of a polyvinyl alcohol (PVA)-based resin film having a thickness of 30 μm (manufactured by Kuraray Co., Ltd., product name: “PE3000”) was uniaxially stretched in its lengthwise direction with a roll stretching machine at a ratio of 5.9 times in the lengthwise direction, and at the same time, was subjected to swelling, dyeing, cross-linking, and washing treatments, followed finally by drying treatment. Thus, a polarizer having a thickness of 12 μm was produced.

Specifically, in the swelling treatment, the film was stretched at a ratio of 2.2 times while being treated with pure water at 20° C. Then, in the dyeing treatment, the film was stretched at a ratio of 1.4 times while being treated in an aqueous solution at 30° C. containing iodine and potassium iodide at a weight ratio of 1:7, the aqueous solution having an iodine concentration adjusted so that the polarizer to be obtained had a single layer transmittance of 45.0%. Further, two-stage cross-linking treatment was adopted for the cross-linking treatment. In the first-stage cross-linking treatment, the film was stretched at a ratio of 1.2 times while being treated in an aqueous solution at 40° C. having dissolved therein boric acid and potassium iodide. The boric acid content and potassium iodide content of the aqueous solution of the first-stage cross-linking treatment were set to 5.0 wt % and 3.0 wt %, respectively. In the second-stage cross-linking treatment, the film was stretched at a ratio of 1.6 times while being treated in an aqueous solution at 65° C. having dissolved therein boric acid and potassium iodide. The boric acid content and potassium iodide content of the aqueous solution of the second-stage cross-linking treatment were set to 4.3 wt % and 5.0 wt %, respectively. In addition, in the washing treatment, the film was treated in a potassium iodide aqueous solution at 20° C. The potassium iodide content of the aqueous solution of the washing treatment was set to 2.6 wt %. Finally, in the drying treatment, the film was dried at 70° C. for 5 minutes. Thus, the polarizer was obtained.

(Production of Polarizing Plate)

A TAC film was bonded to one side of the polarizer through the intermediation of a polyvinyl alcohol-based adhesive to provide a polarizing plate having a configuration “protective layer/polarizer.”

(Production of Optical Laminate)

The polarizer surface of the polarizing plate obtained above and the retardation layer surface of the laminate of the retardation layer and the conductive layer obtained above were bonded to each other through the intermediation of an acrylic pressure-sensitive adhesive. The retardation film was cut so that its slow axis and the absorption axis of the polarizer formed an angle of 45° at the time of their bonding. In addition, the absorption axis of the polarizer was arranged so as to be parallel to a lengthwise direction. Thus, an optical laminate having a configuration “protective layer/polarizer/retardation layer/conductive layer” was obtained.

(Production of Image Display Apparatus Substitute)

A substitute for an organic EL display apparatus was produced as follows. An aluminum metallized film (manufactured by Toray Advanced Film Co., Ltd., product name: “DMS Metallized X-42”, thickness: 50 μm) was bonded to a glass plate with a pressure-sensitive adhesive, and the resultant was used as a substitute for an organic EL display apparatus. A pressure-sensitive adhesive layer was formed on the conductive layer side of the resultant optical laminate using an acrylic pressure-sensitive adhesive. The resultant was cut into dimensions of 50 mm×50 mm and mounted to the organic EL display apparatus substitute, and its reflection hue was measured by the procedure described in the section (3-1). At that time, as a control, a mounted article using an optical laminate having a configuration “protective layer/polarizer/retardation layer” produced in the same manner as above except that the conductive layer was not formed was similarly measured for its reflection hue by the procedure described in the section (3-1).

(Production of Curved Display Apparatus Substitute)

A substitute for a curved display apparatus was produced as follows. The aluminum metallized film “DMS Metallized X-42” was bonded to a desktop nameplate (manufactured by Plus Corporation, L-shaped card stand, width dimension×depth dimension×height dimension: 120 mm×29 mm×60 mm) with a pressure-sensitive adhesive, and the resultant was used as a substitute for a curved display apparatus. An optical laminate having a configuration “protective layer/polarizer/retardation layer” produced in the same manner as above except that the conductive layer was not formed was bonded to the substitute through the intermediation of an acrylic pressure-sensitive adhesive to provide a mounted article. In the optical laminate, the retardation film (retardation layer) was cut so that its slow axis and the absorption axis of the polarizer formed an angle of 45°. In addition, the optical laminate was arranged so that the slow axis of the retardation layer was perpendicular to a direction in which a bent portion extended. A tinge at each of the bent portion and flat portion of the mounted article was visually observed, and evaluation was performed by the criteria described in the section (3-2).

Evaluation indices of the sections (3-1) and (3-2) in the image display apparatus substitute and the curved display apparatus substitute were used as capability indices of the circularly polarizing plate on which the conductive layer was directly formed by sputtering. The results are shown in Table 1.

### Example 2

A polyester carbonate resin was obtained in the same manner as in Example 1 except that 15.10 parts by weight (0.049 mol) of SBI, 42.27 parts by weight (0.289 mol) of ISB, 15.10 parts by weight (0.050 mol) of SPG, 26.22 parts by weight (0.041 mol) of BPFM, 75.14 parts by weight (0.351 mol) of DPC, and 2.05×10⁻³ part by weight (1.16×10⁻⁵ mol) of calcium acetate monohydrate serving as a catalyst were used. The resultant resin had a reduced viscosity of 0.334 dL/g, a glass transition temperature of 157° C., a melt viscosity of 3,020 Pa-s, a refractive index of 1.5360, and a photoelastic coefficient of 12×10⁻¹² m²/N.

A retardation film (thickness: 65 μm) was obtained in the same manner as in Example 1 except that the above-mentioned polyester carbonate resin was used to from a film and the film was uniaxially stretched in its lengthwise direction at a ratio of 1×2.4 times at a stretching temperature of 162° C. and a stretching speed of 5 mm/sec. The resultant retardation film had an Re(550) of 140 nm and an Rth(550) of 140 nm, and showed a refractive index characteristic of nx>ny=nz. In addition, the resultant retardation film had a ratio Re(450)/Re(550) of 0.86. The slow axis direction of the retardation film was 0° with respect to its lengthwise direction.

### Comparative Example 1

An optical laminate and an organic EL display apparatus substitute were produced in the same manner as in Example 1 except that a commercially available polycarbonate resin film (manufactured by Teijin Limited, product name: “PURE-ACE WR”) was used as the retardation layer. The resultant organic EL display apparatus substitute was evaluated in the same manner as in Example 1. The results are shown in Table 1.

### Comparative Example 2

A polycarbonate resin was obtained in the same manner as in Example 1 except that: 60.43 parts by weight (0.199 mol) of SPG, 32.20 parts by weight (0.085 mol) of BCF, 64.40 parts by weight (0.301 mol) of DPC, and 2.50×10⁻³ part by weight (1.42×10⁻⁵ mol) of calcium acetate monohydrate serving as a catalyst were used; and the final polymerization temperature was set to 260° C. The resultant resin had a reduced viscosity of 0.499 dL/g, a glass transition temperature of 135° C., a melt viscosity of 2,940 Pa·s, a refractive index of 1.5334, and a photoelastic coefficient of 13×10⁻¹² m²/N. An optical laminate and an organic EL display apparatus substitute were produced in the same manner as in Example 1 except that a film formed from the polycarbonate resin was used. The resultant organic EL display apparatus substitute was evaluated in the same manner as in Example 1. The results are shown in Table 1.

### Comparative Example 3

An optical laminate and an organic EL display apparatus substitute were produced in the same manner as in Example 1 except that a commercially available cycloolefin-based resin film (manufactured by Zeon Corporation, product name: “ZEONOR”, in-plane retardation: 147 nm) was used as the retardation layer. The resultant organic EL display apparatus substitute was evaluated in the same manner as in Example 1. The results are shown in Table 1.

### Comparative Example 4

The retardation layer used in Comparative Example 1 was bonded to the polarizing plate used in Example 1 to provide a circularly polarizing plate having a configuration “protective layer/polarizer/retardation layer.” Meanwhile, a commercially available cycloolefin-based resin film (manufactured by Zeon Corporation, product name: “ZEONOR”, in-plane retardation: 3 nm) was used as a substrate, and a transparent conductive layer formed of an indium-tin composite oxide was formed on the surface of the substrate by sputtering in the same manner as in Example 1. The retardation layer surface of the circularly polarizing plate and the conductive layer surface of the laminate of the substrate and the conductive layer were bonded to each other with an acrylic pressure-sensitive adhesive to provide an optical laminate having a configuration “protective layer/polarizer/retardation layer/conductive layer/substrate.” An organic EL display apparatus was produced in the same manner as in Example 1 except that this optical laminate was used. The resultant organic EL display apparatus was evaluated in the same manner as in Example 1. The results are shown in Table 1.

TABLE 1

| | | | | | | Color | |
|---|---|---|---|---|---|---|---|
| | | | | | | unevenness at | Number of |
| | Retardation layer | | | Reflection hue | | bent portion | laminated films |
| | | Photoelastic | | Without | With | Without | Configuration |
| | Tg | coefficient | Re(450)/ | conductive | conductive | conductive | with conductive |
| | (° C.) | (×10⁻¹²) | Re(550) | layer | layer | layer | layer |
| Example 1 | 165 | 15 | 0.81 | ∘ | ∘ | ∘ | 4 |
| Example 2 | 157 | 12 | 0.86 | ∘ | ∘ | ∘ | 4 |
| Comparative | 210 | 40 | 0.92 | ∘ | ∘ | x | 4 |
| Example 1 | | | | | | | |
| Comparative | 135 | 13 | 0.92 | ∘ | x | ∘ | 4 |
| Example 2 | | | | | | | |
| Comparative | 160 | 9 | 1.00 | x | x | ∘ | 4 |
| Example 3 | | | | | | | |
| Comparative | 210 | 40 | 0.92 | ∘ | ∘ | x | 5 |
| Example 4 | | | | | | | |

[Evaluation]

As is apparent from Table 1, it is found that by setting the Tg, photoelastic coefficient, and wavelength dependence of the retardation layer to predetermined ranges in combination, desired optical characteristics can be maintained even when the conductive layer is directly formed on its surface by sputtering. Comparative Example 1 using a retardation layer having a large photoelastic coefficient is inferior in color unevenness at the bent portion. Comparative Example 2 using a retardation layer having a low Tg is inferior in reflection hue as a result of the formation (sputtering) of the conductive layer. Comparative Example 3 using a retardation layer having a flat wavelength dispersion characteristic is inferior in reflection hue irrespective of the presence or absence of the conductive layer (sputtering). Comparative Example 4, in which the conductive layer is formed on the substrate and the laminate of the substrate and the conductive layer is bonded, has a thickness increased by the thicknesses of the substrate and the pressure-sensitive adhesive layer for bonding. Further, Comparative Example 4 is inferior in color unevenness at the bent portion.

### INDUSTRIAL APPLICABILITY

The optical laminate of the present invention can be suitably used for an image display apparatus (typically a liquid crystal display apparatus or an organic EL display apparatus).

### REFERENCE SIGNS LIST

10 polarizer
20 retardation layer (retardation film)
30 conductive layer
40 protective layer
100 optical laminate

1. An optical laminate, comprising:
a polarizer;
a retardation layer; and
a conductive layer, which is directly formed on the retardation layer,
wherein the retardation layer has an in-plane retardation Re(550) being from 100 nm to 180 nm and satisfying a relationship of Re(450)<Re(550)<Re(650), and has a glass transition temperature (Tg) of 150° C. or more and an absolute value of a photoelastic coefficient of 20×10⁻¹² (m²/N) or less, and
wherein an angle formed between a slow axis of the retardation layer and an absorption axis of the polarizer is from 35° to 55°.

2. The optical laminate according to claim 1, wherein the retardation layer is formed of a polycarbonate resin containing at least a structural unit represented by the below-indicated formula (1) or (2): 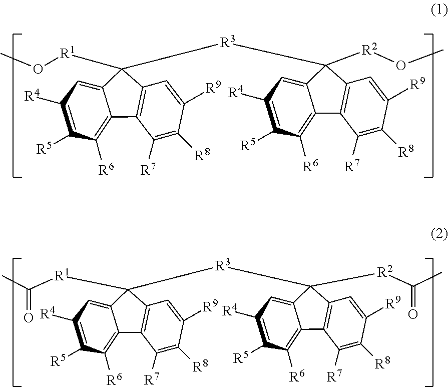
in the formulae (1) and (2), R¹ to R³ each independently represent a direct bond, or an alkylene group having 1 to 4 carbon atoms that may have a substituent, and R⁴ to R⁹ each independently represent a hydrogen atom, an alkyl group having 1 to 10 carbon atoms that may have a substituent, an aryl group having 4 to 10 carbon atoms that may have a substituent, an acyl group having 1 to 10 carbon atoms that may have a substituent, an alkoxy group having 1 to 10 carbon atoms that may have a substituent, an aryloxy group having 1 to 10 carbon atoms that may have a substituent, an amino group that may have a substituent, a vinyl group having 1 to 10 carbon atoms that may have a substituent, an ethynyl group having 1 to 10 carbon atoms that may have a substituent, a sulfur atom having a substituent, a silicon atom having a substituent, a halogen atom, a nitro group, or a cyano group, provided that R⁴ to R⁹ may be identical to or different from each other, and at least two adjacent groups of R⁴ to R⁹ may be bonded to each other to form a ring.

3. The optical laminate according to claim 2, wherein the retardation layer is formed of a polycarbonate resin containing at least a structural unit represented by the below-indicated formula (3): 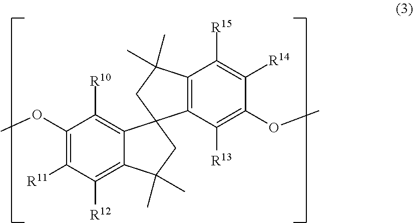
in the formula (3), R¹⁰ to R¹⁵ each independently represent a hydrogen atom, an alkyl group having 1 to 12 carbon atoms, an aryl group, an alkoxy group having 1 to 12 carbon atoms, or a halogen atom.

4. The optical laminate according to any claim 3, wherein the retardation layer is formed of a polycarbonate resin containing at least a structural unit represented by the below-indicated formula (4).

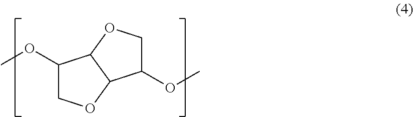

5. The optical laminate according to claim 2, wherein the polycarbonate resin has a melt viscosity of 3,000 Pa·s or more and 7,000 Pa·s or less at a measurement temperature of 240° C. and a shear rate of 91.2 sec⁻¹.

6. The optical laminate according to claim 2, wherein the polycarbonate resin has a refractive index of 1.49 or more and 1.56 or less at a sodium d-line (589 nm).

7. The optical laminate according to claim 2, further comprising a protective layer, which is bonded to an opposite side of the polarizer to the retardation layer.

8. The optical laminate according to any claim 7, further comprising a protective layer between the polarizer and the retardation layer.

9. An image display apparatus, comprising the optical laminate of claim 1 on a viewer side, wherein the polarizer of the optical laminate is arranged on the viewer side.
